(19) United States
(12) Patent Application Publication
(10) Pub. No.: US 2002/0104251 A1
(43) Pub. Date: Aug. 8, 2002

(54) Topwater fishing lure

(76) Inventor: Randall Isaac Prescott, Clayton (CA)

Correspondence Address: MARKS & CLERK, 350 BURNHAMTHORPE ROAD WEST, SUITE 402, MISSISSAUGA, ON, L5B 3J1, CA

(21) Appl. No.: 10/061,254

(22) Filed: Feb. 4, 2002

(30) Foreign Application Priority Data
Feb. 5, 2001 (CA) 2334650

(51) Int. Cl. A01K 85/00

(52) U.S. Cl. 43/42.48

(57) ABSTRACT

A topwater fishing lure is provided which comprises a hard body with a concave section at one end. The lure is designed so that the concave section floats above the surface of the water, and when pulled with a fishing line, the lure will topple over to immerse the concave section in the water. By doing so, the lure generates a noise which can act as an attractant to nearby fish. The lure may also contain two hooks with soft body devices attached to opposite sides of the hard body, which hooks hang straight down in the water to simulate the appearance of a frog, as bait.

### FIELD OF THE INVENTION

The present invention generally relates to fishing lures, and more particularly to fishing lures which float.

### BACKGROUND OF THE INVENTION

A wide variety of fishing lures are currently known and are commercially available. Various lure shapes and sizes are known and have met with some success. However, the fisher is constantly seeking novel fishing lures which will provide improved performance.

While some lures are designed to sink below the surface of the water, one group of lures is designed to float on the surface. These so-called “topwater” lures are commonly available. Suitable topwater lures are commonly made to resemble baits such as frogs, or small fish which might stay near the surface of the water.

One specific type of topwater lure is termed in the industry as a “popper”. Popper lures are commonly, commercially available as, for example, the “Skitter Pop”, the “Z-popper”, the ‘Hula Popper”, the “Pencil Popper”, or the like. Typically these types of lures have the appearance of a fish and float horizontally on the surface of the water. At one end (usually the mouth end of a simulated fish), they have a concave section which rests partially immersed under the water surface. The fishing line is attached in, or near, the centre of the concave section so that as the fishing line is retracted the concave section is pulled through the surface of the water and creates a splashing noise. By quickly making a series of pulls on the fishing rod, a series of splashing noises can be generated. These noises can aid in attracting the fish to the site of the lure since they can mimic the sound of an injured or distressed fish, or other bait.

These lures are typically made of hard materials in order to maintain their shape when moving through the water, and thus can lose some of the advantages of lures made of softer materials (“soft body” lures). These advantages can include the flexibility to move and thus present a more life-like appearance. Also, the “hard body” lures typically have hooks or other features which are not readily interchangeable, and thus, adapting the lure for changing fishing conditions can be difficult.

Also, when a fishing lure has been cast into a particularly preferred location, it is necessary to move the lure several meters in order to make the splashing noise used to attract the fish. If the lure is located in a weed bed, it is possible that moving the lure to create the splashing noise will cause the lure to become snagged in the weeds.

### SUMMARY OF THE INVENTION

Accordingly, it is a principal object of the present invention to provide a fishing lure which can create a fish-attractive noise without excessive movement.

It is a further object of the present invention to provide a fishing lure to which soft body lure parts can be attached, and/or wherein hooks and the like can be readily changed depending of conditions.

It is a further object of the present invention to provide a fishing lure which is resistant to snagging on weed.

The foregoing objects are attained by providing a topwater fishing lure which floats on the surface of the water so as keep the concave section of the lure out of the water, and which will topple over when pulled to generate a distinctive noise as the concave section breaks the surface of the water.

Accordingly, the present invention provides a topwater fishing lure comprising a hard body portion with, preferably, an essentially circular, concave section, a line attachment point located at or near the centre of said concave section to which a fishing line can be attached, and at least one hook attachment point, located on said hard body section, outside of said concave section, characterized in that said fishing lure is weighted so that said hard body section floats on the surface of the water, with said concave section orientated so as to be essentially above the water line.

### DETAILED DESCRIPTION OF THE INVENTION

The lure is preferably designed so that the lure will float with the concave section pointed essentially perpendicular to the surface of the water. This can be achieved by the addition of weight to the lure, but is more preferably accomplished by designing the hard body section of the lure so that it normally floats with this orientation. The weight from the one or more hooks can also aid in accomplishing the correct floating orientation.

By connecting the fishing line to the centre of the concave section, the initial retraction of the fishing line will cause the fish lure to topple over so that the concave section will break the surface of the water. With sufficient initial retraction force, the concave section will topple over so that the concave section will become temporarily completely immersed under the surface of the water. As the concave section becomes completely immersed, it generates a noise in a manner similar to the “poppers” described hereinabove.

However, the lure of the present invention has distinct advantages over the prior art poppers. In particular, the noise made by the lure of the present invention creates an initial “plopping” noise as the concave surface becomes completely immersed under the water. The plopping noise would be similar to the noise of a frog landing in the water, and thus would be attractive to the fish. The differences in noises between the lure of the present invention and the prior art, is the initial “plopping” noise as the lure topples over. This would be analogous to pushing a cupped hand through the surface of the water, as opposed to forcing a cupped hand straight down into the water.

Further, the lure of the present invention can create the plopping noise merely by toppling over. It is not necessary for the lure to move any significant distance to create a sound. Thus, the fisher can generate a series of “plopping” noise without any real movement of the lure, by simply making a series of short, quick pulls on the fishing line. Accordingly, the lure can be cast to a preferred position, and essentially left in that position, even when the attractive “plopping” sound is made by causing the lure to topple over.

This can also reduce the possibility of snagging on weeds since the lure does not have to be moved in order to generate the fish-attractive noise.

A preferred shape for the hard body section of the lure is a truncated cylinder wherein one end of the cylinder has a circular, concave section, and the other end of the cylinder is truncated from preferably opposite sides so as to create a ridge across the bottom of the cylinder, and two essentially flat sections on each side of the truncated cylinder.

Because of this preferred design of a truncated cylindrical shape, it is possible to create a deeper concave section that with prior art fish-designed poppers. Thus, it is possible to create a lure with more capacity to store (and release) air bubbles as the lure is inverted. The flat surfaces also provide convenient surfaces for the attachment of fish hooks, as outlined hereinbelow.

It should be noted that as the fish lure of the present invention is reeled-in, it would also make a splashing noise, similar to the prior art lures, as the concave section is pulled through the surface of the water. Further, since the lure of the present invention relies on the “toppling” action of the lure when first moved, it is possible to use fishing line of higher strength, and still achieve the noise making ability. In prior art devices, higher strength lines would interfere with the correct operation of the lure, and thus, the fisher was restricted to lower strength fishing lines.

It has also been stated that the topwater lure of the present invention has at least one hook. However, in a preferred embodiment, the lure of the present invention has two hooks. These can be attached to the hard body of the lure using screw eye connectors, or any other suitable attachment method, so that the hooks can be easily removed and changed. This allows for rapid changes in the lure depending on fishing conditions.

Also, in a preferred embodiment, the two hooks are mounted on the hard body on opposite sides and are free to hand down from the hard body. The hook can also be mounted in combination with soft body devices, such as tube baits, soft plastic baits or the like. These tube baits or soft plastic baits can be obtained in a wide variety of colours, and can be rapidly exchanged in the same manner as the hooks. The soft body device might also be a recycled soft body bait that can now be used in combination with the hard body of the lure of the present invention. The hooks can also be partially hooked into the soft body of the tube bait, or other soft body device, to reduce the chances of snagging the hooks on weeds. Accordingly, this design allows for a so-called weedless arrangement of the hooks.

However, while the device of the present invention may be advantageously used in weedy conditions, it may also be used in open water which is essentially free from weeds near the water surface.

In a further preferred feature, the hooks and soft body devices, can be arranged so that they hang down in the water, on opposite sides of the hard body. Through this presentation in the water, the top water lure can provide a reasonable simulation of a frog, which would also have a similar presentation. Together with the noise from concave section, the lure of the present invention, would provide a reasonable simulation of a frog.

The hard body can be produced of any suitable material including plastics and the like, provided that the lure, as a whole, floats in the manner specified above. However, a preferred material is wood. Lures made of wood will typically provide sufficient weight so that the lure can be cast a reasonable distance without the need for any additional weighting.

The shape of the hard body can vary, but a truncated cylindrical shape, with a concave section at a non-truncated end has been found to be most useful. The hooks and soft body devices can then be attached generally on opposite sides of the hard body, and located preferably below the centre of gravity of the hard body, so as to assist in maintaining the hard body orientation with the concave section facing upwards.

In a further feature, the hard body of the lure of the present invention, may have holes drilled from the concave centre section, through to the outside of the lure. This will allow water to pass through this holes as the lure is reeled in. This can assist in reducing the drag of the lure, or might be used to cause, or prevent, spinning of the lure.

Other features of the present invention, as well as other objects and advantages attendant thereto, are set forth in the following description and the accompanying drawings in which like reference numerals depict like elements.

### BRIEF DESCRIPTION OF THE DRAWINGS

One embodiment of the topwater fishing lure of the present invention will now be described by reference to the following drawings wherein:

FIG. 1 is a front plan view of a lure according to the present invention;

FIG. 2 is a cross-sectional view of the lure of FIG. 1 along the line 2-2;

FIG. 3 is a top view of the lure of FIG. 1; and

FIG. 4 is a top, perspective view of the lure of FIG. 1.

In the drawings, like numerals are used to indicate common parts

### DETAILED DESCRIPTION OF A PREFERRED EMBODIMENT

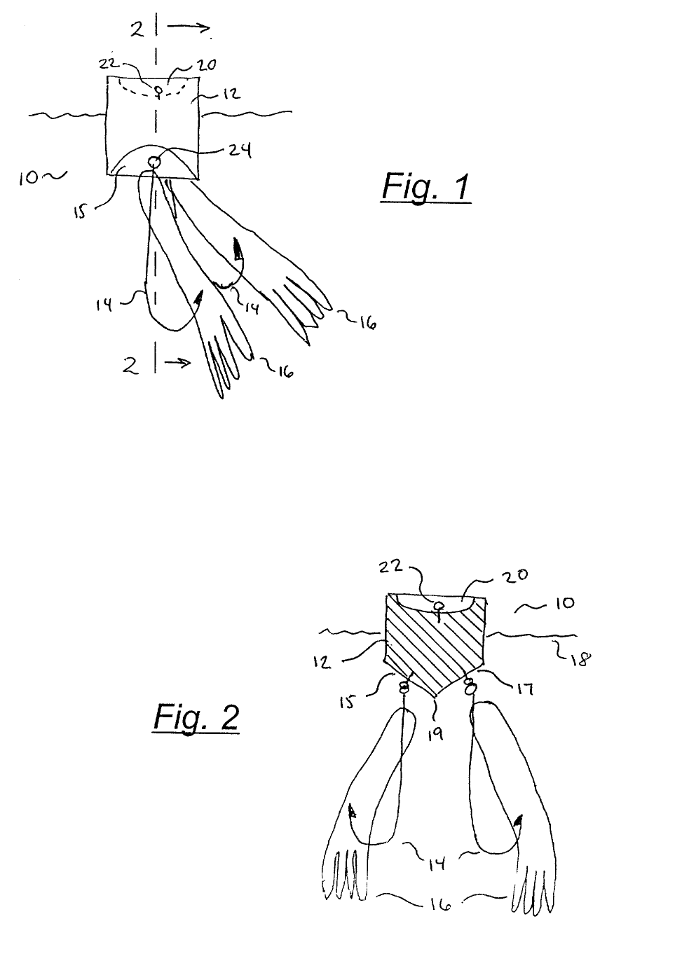

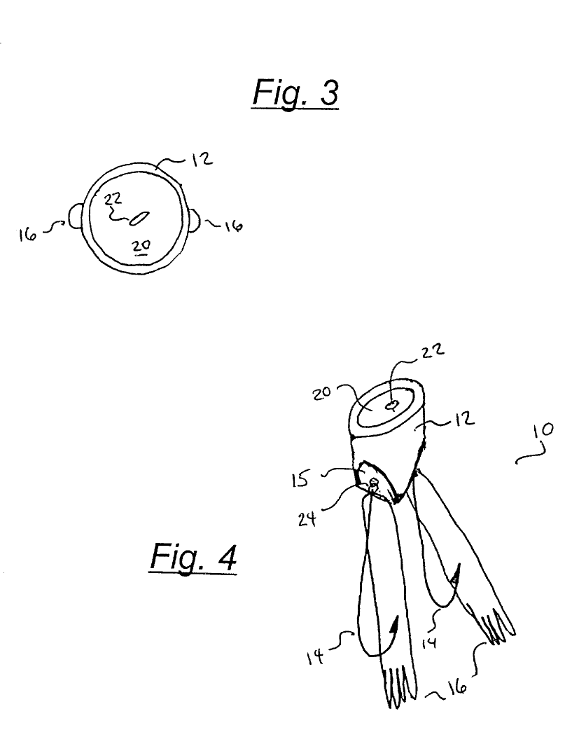

In FIGS. 1 to 4, a topwater lure 10 according to the present invention is shown, which comprises a hard body section 12, two hooks (both designated as 14), and two tube baits (both designated as 16). Hard body 12 is generally a truncated cylinder have a diameter of 2.5 cm and a length of 4 cm, and is made of wood. At the non-truncated end of the cylinder, a concave section 20 has been made which extends 1 cm into the hard body.

On each side, the cylinder has been truncated to form to essentially flat sections 15 and 17 which meet and form a ridge section 19.

At the centre of concave section 20 is a line attachment screw eyelet 22 to which a fishing line (not shown) can be attached. On opposite sides of hard body 12 are hook attachment eyelets 24. Using connectors 24, two hooks 14 are attached to lure 10.

Hooks 14 have been inserted through the ends of tube baits 16 so that the tube baits are also attached to lure 10. This might also be accomplished by having the tube baits connect to separate attachment eyelets or other devices. Tube baits 16 are made of a soft rubbery plastic, and can be filled, if desired, with standard tube bait attractants. Because of their soft rubbery composition, tube baits 16 hang down to be essentially parallel to hooks 14. Hooks 14 can be partially hooked into tube baits 16 in order to reduce the chances of hooks 14 snagging on weeds, or the like.

In use, lure 10 would float at the surface of the water (shown as 18 in FIG. 2) so that concave section 20 is out of the water. When the fisher initiates a short rapid retraction of the fishing line, lure 10 will “topple” over so that concave section 20 will become immersed in the water, and thus produce a distinctive sound. Release of the line will allow lure 10 to return to its normal, floating upright position.

Using this technique, a sound can be produced from lure 10, with little or no lateral movement of lure 10.

Thus, it is apparent that there has been provided, in accordance with the present invention, a topwater fishing lure which fully satisfies the means, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

The embodiments of the invention in which an exclusive property or privilege is claimed are defined as follows:

1. A topwater fishing lure comprising a hard body portion with an essentially circular concave section, a line attachment point located at or near the centre of said concave section to which a fishing line can be attached, and at least one hook attachment point, located on said hard body section, outside of said concave section, characterized in that said fishing lure is weighted so that said hard body section floats on the surface of the water with said concave section orientated so as to be essentially above the water line.

2. A lure as claimed in claim 1 wherein the lure floats at the surface of the water with the concave section pointed essentially perpendicular to the surface of the water.

3. A lure as claimed in claim 1 wherein an initial retraction of an attached fishing line causes the fish lure to topple over so that the concave section will break the surface of the water, and becomes temporarily completely immersed under the surface of the water.

4. A lure as claimed in claim 1 where said lure has two hooks.

5. A lure as claimed in claim 4 wherein said hooks are attached to the hard body of the lure using screw eye connectors.

6. A lure as claimed in claim 4 wherein said hooks are mounted on opposite sides of the hard body and are free to hand down from the hard body.

7. A lure as claimed in claim 1 wherein said hook is mounted in combination with soft body devices.

8. A lure as claimed in claim 7 wherein said soft body device is a tube baits or a soft plastic bait.

9. A lure as claimed in claim 7 wherein said hook is at least partially hooked into the soft body device so as to reduce the chances of snagging the hooks on weeds.

10. A lure as claimed in claim 1 wherein said hard body is made of wood.

11. A lure as claimed in claim 1 wherein said hard body has a truncated cylindrical shape, with a concave section at a non-truncated end.

12. A lure as claimed in claim 11 wherein said hooks are attached to opposite sides of the hard body, and located below the centre of gravity of the hard body.

13. A lure as claimed in claim 11 having a truncated section of opposite sides of said cylinder so as to create two flat sections with a ridge located between the flat sections.

14. A lure as claimed in claim 1 wherein said hard body comprises holes drilled from the concave centre section, through to the outside of the lure.
